(19) United States
(12) Patent Application Publication
(10) Pub. No.: US 2002/0108326 A1
(43) Pub. Date: Aug. 15, 2002

(54) Window flashing

(76) Inventor: Dale S. Ackerman JR., Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/114,756

(22) Filed: Apr. 2, 2002

Related U.S. Application Data
(63) Continuation-in-part of application No. 09/942,083, filed on Aug. 28, 2001.
Application No. 09/942,083 is a continuation-in-part of application No. 09/567,866, filed on May 9, 2000, now Pat. No. 6,305,130.

(51) Int. Cl. E06B 3/00

(52) U.S. Cl. 52/204.5

(57) ABSTRACT

A flashing assembly includes an inner lip that fits within a rough opening. Bonded to the inner lip is an outer flange that covers a portion of a wall around a rough opening. An outer flap is bonded to the outer flange. Once a window or door is installed in the rough opening, the outer flap is sealed to a nailing flange of the window. In one embodiment of the invention, the inner lip and at least a portion of the outer flange and potentially the outer flap are formed of an extrusion. Alternatively, the inner lip and outer flange may be adhered to the window or door jamb and nailing flange.

### CROSS-REFERENCES TO RELATED APPLICATIONS

The present application is a continuation-in-part of prior U.S. patent application Ser. No. 09/942,083 filed Aug. 28, 2001 which is a continuation-in-part of U.S. patent application Ser. No. 09/567,866, filed May 9, 2000 now U.S. Pat. No. 6,305,130, the benefit of the filing dates being claimed under 35 U.S.C. §120.

### FIELD OF THE INVENTION

The present invention relates to building materials in general, and in particular, to seals for windows.

### BACKGROUND OF THE INVENTION

One of the most common failure points where water enters a building's envelope is around windows and doors. Water penetration is one of the most significant factors leading to premature failures of structures. Many windows and doors, whether they are aluminum or vinyl, are secured in the building's rough opening by a nailing flange. As an example, the window is placed in the rough opening from the outside and secured using nail or screw fasteners that are driven through the window's nailing flange. Installation methods vary significantly and range from as little as building paper lapping over or under the window flange to flashing materials being shingled in the rough opening prior to window installation, application of caulking installed from a tube caulk gun under the window flange, and various flashing or adhesive tapes applied over the window flange. Installation is often performed from ladders or scaffolding at various levels above the ground. Flashing materials are often misaligned or applied in an inconsistent manner that leaves wrinkles or voids in the material leading to leaks, i.e., direct water pathways to the underlying building materials. The flashing is assembled from numerous separate components that when installed cover each other, making inspection of the completed flashing assembly extremely difficult. Further, since there is often a time lapse between installation of the various components, they are often damaged by wind, rain, or other mechanical disturbances.

Given these problems, there is a need for an improved method of ensuring a weather-tight barrier for window installations.

### SUMMARY OF THE INVENTION

The present invention is a window flashing assembly that includes an inner lip that fits within the interior surface of a rough opening. The inner lip may have an integrally formed water and air barrier to seal the rough opening to window jamb gap. The inner lip may have an adhesive strip with removable backing to adhere the inner lip to the inside surface of the rough opening or weather resistive barrier that has been extended into the rough opening. Alternatively the inner lip may extend beyond sealing areas providing an area to staple the inner lip to the inside of the rough opening. The inner lip may be partially or fully formed by an extrusion of a rubber type material that may be integrally adhered to a weather resistive material.

Bonded to the inner lip is an outer flange that covers a portion of the wall surrounding the rough opening. A compressible seal, that may have several collapsing sealing fins, may be placed on the outer surface of the outer flange where it has contact with the inner surface of the nailing flange. The inner surface of the outer flange may have an adhesive material with removable backing for adhesion to a weather resistive barrier covering the buildings exterior wall surface. The inner surface of the outer flange may have an integrally formed compressible seal that may have several collapsing sealing fins that corresponds to the outer surface compressible seal. The outer flange may have stiffeners to further assure the assembly maintains integrity. The outer flange may be extended beyond the point where the outer flap is joined. The extension may allow an area to staple the outer flange to the buildings exterior sheathing and further cover the wall surface. The outer flange may be partially or fully formed by an extrusion of a rubber type material that may be integrally adhered to a weather resistive material.

The outer flange is preferably integrally formed to the outer flap. The outer flap may have an adhesive material on its inner surface at the point of contact with the outer surface of the nailing flange. The adhesive is preferably covered with a removable backing material. Upon securing the window into the rough opening, the backing material may be removed from the adhesive on the outer flap such that it is secured over the nailing flange on the window in order to provide a watertight seal. The outer flap may be formed by an extrusion of a rubber type material or may be formed from weather resistive material.

The outer flange and outer flaps may be alternately interwoven such that each section and layer is shingled so that water moving down the assembly will be kept away from the building.

The inner lip and outer flange may be over laid with a corner block to further seal the comer of the rough opening. The corner block may include an interlock over the water and air barrier for the rough opening.

Another preferred embodiment of the invention is an extrusion made from a pliable rubber type material. The invention has an inner lip that is adhesively attached to the inner window or door jamb. The inner lip may have an integrally formed water and air barrier to fill the rough opening to window or door gap.

The inner lip is preferably integrally formed to the outer flange. The outer flange is adhesively attached to the windows or door inner surface of the nailing flange. The outer flange inner surface has an integrally formed compressible seal that may have several fins to engage the outer surface of a weather resistive barrier covering the building sheathing surrounding the rough opening.

In one embodiment of the invention the outer flap has an adhesive material with removable backing on its inner surface placed to be aligned with the outer surface of the nailing flange.

Upon securing the window into the rough opening, the backing material of the outer flap is removed and the outer flap is adhesively secured over the nailing flange to provide a watertight seal.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a window flashing assembly in accordance with one embodiment of the present invention;

FIG. 2 illustrates how the window flashing assembly shown in FIG. 1 is installed to form a weather-tight seal around a window;

FIG. 3 is a cross-sectional view of a window flashing assembly according to the present invention;

FIG. 4 illustrates a window flashing assembly according to a second embodiment of the present invention;

FIG. 5 illustrates a portion of a window flashing assembly made from an extrusion in accordance with one embodiment of the invention;

FIG. 6 illustrates how the extruded window flashing assembly is used in a rough opening;

FIG. 7 illustrates a comer block used to seal the comers of a window sealed with the extruded flashing assemblies;

FIG. 8 illustrates a more rigid extruded flashing assembly in accordance with another embodiment of the present invention;

FIG. 9 illustrates another embodiment of the flashing assembly installed over a weather resistive barrier that extends into the rough opening;

FIG. 10 illustrates another embodiment of the flashing assembly installed over a weather resistive barrier that extends into the rough opening and sealed by inner and outer compressible sealing fins integrated into the outer flange; and

FIG. 11 illustrates another embodiment of the flashing assembly adhered to the window jamb and adjacent window nailing flange.

### DETAILED DESCRIPTION OF THE PREFERRED EMBODIMENT

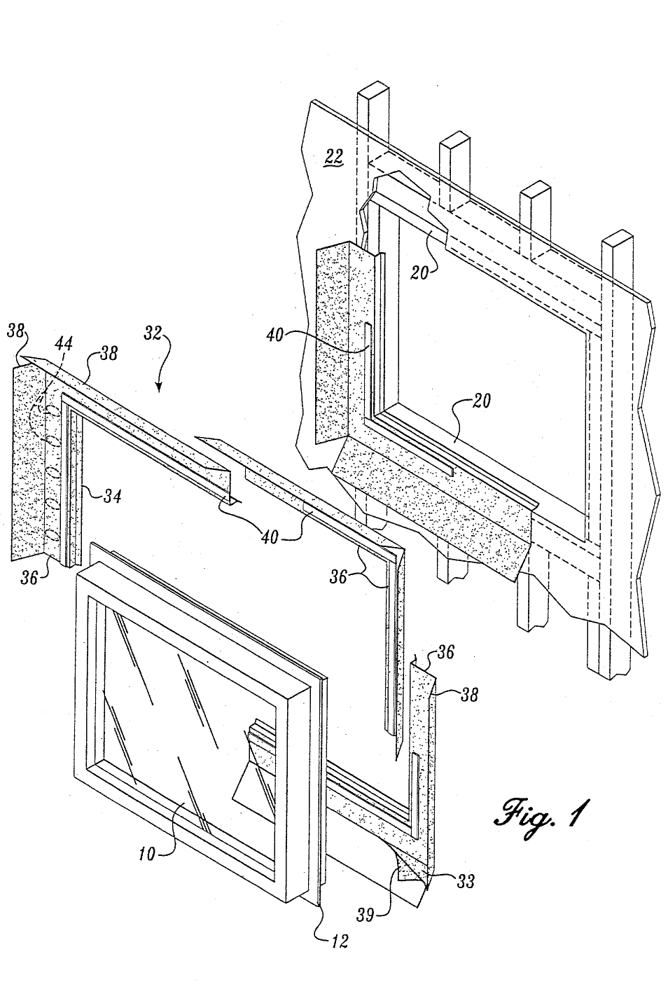

The present invention is a window flashing assembly that provides an improved barrier to weather. As shown in FIG. 1, a window 10 is to be installed in a rough opening 20 that is formed within a wall 22. The window 10 has a nailing flange 12 that surrounds its perimeter through which one or more fasteners are inserted in order to secure the window 10 into the rough opening 20.

To prevent moisture from seeping in behind the nailing flange 12, a series of flashing assemblies 32 is placed into the rough opening 20 prior to the installation of the window 10. Each flashing assembly 32 has an inner lip 34 that covers at least a portion of an inner surface of the rough opening. The inner lip 34 is joined with an outer flange 36 that covers a portion of the exterior of the wall 22 surrounding the rough opening 20. Bonded to the outer edge of the flange 36 is an outer flap 38 that is folded back over the nailing flange 12 of the installed window to form a watertight seal.

In addition, the window flashing assembly 32 may include a weather strip 40 disposed on the outer flange 36 around the rough opening such that when the window is installed into the rough opening the weather strip 40 engages the inner surface of the nailing flange 12. The weather strip 40 provides a further barrier to moisture.

The outer flange 36 is preferably made of a building paper or other waterproof flexible materials and may include one or more stiffening members 44.

The outer flaps 38 may have an adhesive 33 covering their inner surface. The adhesive is covered with a removable backing material 39 that is pulled away from the adhesive prior to covering the nailing flange. In an embodiment of the invention, each of the flashing assemblies 32 is formed as an L-shaped section having two legs that meet at approximately 90 degrees, such that there are no seams in the corners of rough opening 20. With an L-shaped flashing assembly installed into each comer of the rough opening, the legs overlap by varying amounts depending on the dimensions of the rough opening. Although the flashing assemblies are preferably designed for square or rectangular windows, it will be appreciated that the present invention could be used to seal differently shaped windows, such as circular, octagonal, etc. In addition, the flashing could also be used with other structures such as doors or other areas where water damage is likely.

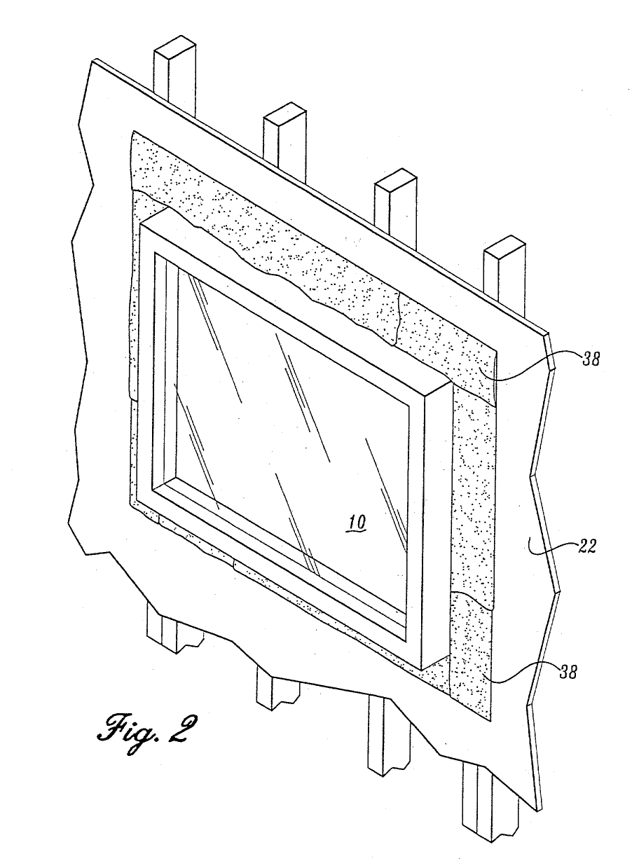

FIG. 2 illustrates the installation of the window 10 in the wall 22 when the outer flaps 38 have been sealed over the nailing flange. The outer flaps 38 are preferably folded over the nailing flange beginning with the bottom of the window followed by the sides, and finally the top such that the outer flaps 38 are shingled over the nailing flange so that any water that meets the flange will be directed away from the rough opening. The outer flange is shingled in the same manner.

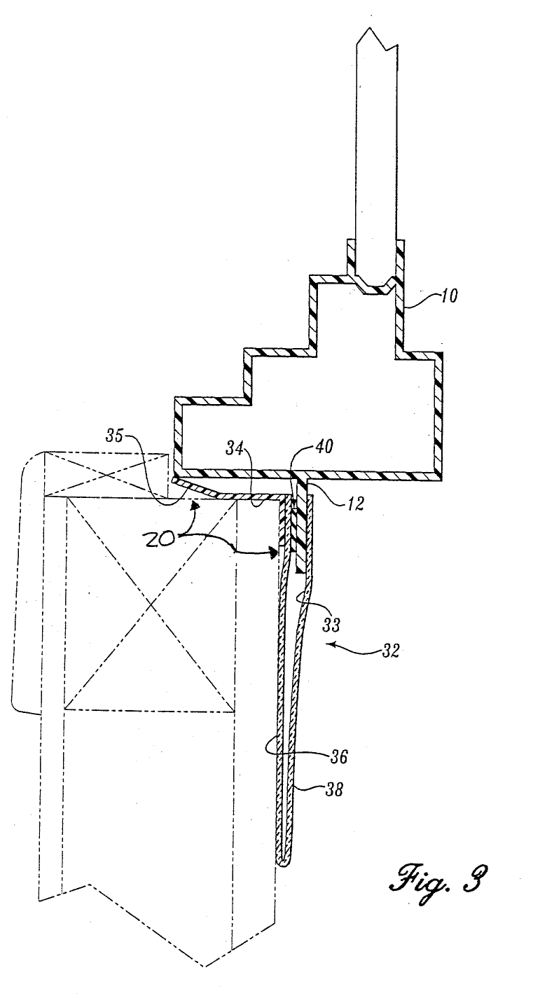

FIG. 3 shows a cross-sectional view of a flashing assembly 32 installed in a rough opening 20. As indicated above, each flashing assembly 32 includes an inner lip 34 that fits within the interior surface of the rough opening and aids in the proper alignment of the flange in the opening. The inner lip 34 may have a slightly raised portion that forms a water dam or air barrier 35 at the inner edge of the lip 34. The water air dam 35 ensures that any water that does manage to get behind the nailing flange 12 of the window is directed towards the exterior surface of the wall. The water air dam also performs the function of sealing the rough opening to jamb gap eliminating the need for backer rod or other fillers.

Bonded to the inner lip 34 is the outer flange 36 that covers a portion of the wall surrounding the rough opening 20. When installed, the nailing flange of the window lies over a portion of the outer flange 36. The outer flange 36 is preferably made of a building paper or other waterproof flexible materials and may include one or more stiffening members (44 as shown in FIG. 1) to add strength. The outer flange 36 also includes an outer flap 38 along its outer edge. The outer flap 38 has an adhesive on its interior surface. As indicated above, once the window 10 is installed into the rough opening, a backing layer is removed from the adhesive and the outer flap 38 is folded over the nailing flange 12 in order to provide a waterproof seal such that the nailing flange 12 is sandwiched between the outer flange 36 and the outer flap 38.

In addition, the window flashing assembly 32 may include a weather strip 40 disposed on the outer flange 36 around the rough opening such that when the window is installed into the rough opening the weather strip 40 engages the inner surface of the nailing flange 12. The weather strip 40 provides a further barrier to moisture.

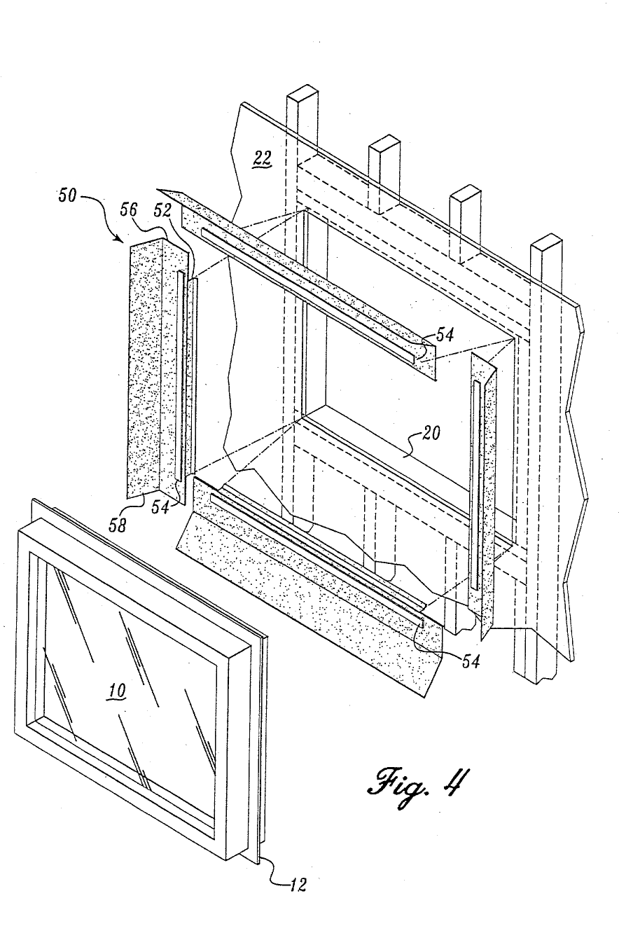

FIG. 4 shows an alternative embodiment of the present invention. As opposed to the embodiment shown in FIGS. 1 and 2, a window flashing assembly 50 is formed as a straight section rather than the L-shaped section. The straight window flashing sections 50 can be used alone in order to seal a window in a rough opening. Alternatively, the flashing assemblies 50 can be used in combination with the L-shape flashing assemblies in order to extend the size of a window that can be sealed.

As with the previously disclosed embodiment, the window flashing 50 assembly includes an inner lip 52 that fits within the inner surface of a rough opening. An outer flange 56 is bonded to the inner lip 52 and covers a portion of the wall 22 surrounding the rough opening. Bonded to the outer edge of the outer flange 56 is an outer flap 58 having an adhesive on its inner surface that is covered with a backing material. Once the window 10 is installed in the rough opening 20, the backing material is removed and the outer flap 58 is secured over the nailing flange 12 of the window 10. In addition, the flashing assembly may include a weather strip 54 near the junction of the inner lip 52 and the outer flange.

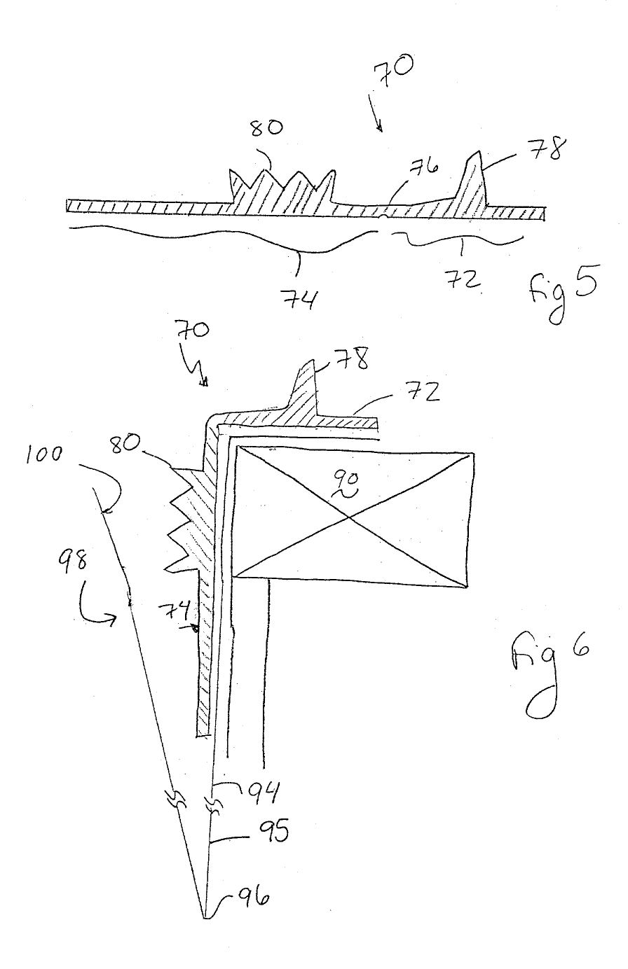

FIG. 5 shows another alternative embodiment of a flashing assembly of the present invention. A flashing assembly includes an extruded member 70 that includes an inner lip 72 that fits within at least a portion of the rough opening and an outer flange 74 that covers at least a portion of the wall surrounding the rough opening. The inner lip 72 and outer flange 74 are joined at a flexible hinge 76, about which the extrusion can be folded when inserted into a rough opening. In addition, the extrusion may include an integrally formed water dam/air barrier 78 on the inner lip 72 and an integrally formed weather strip 80 positioned on the outer flange 74.

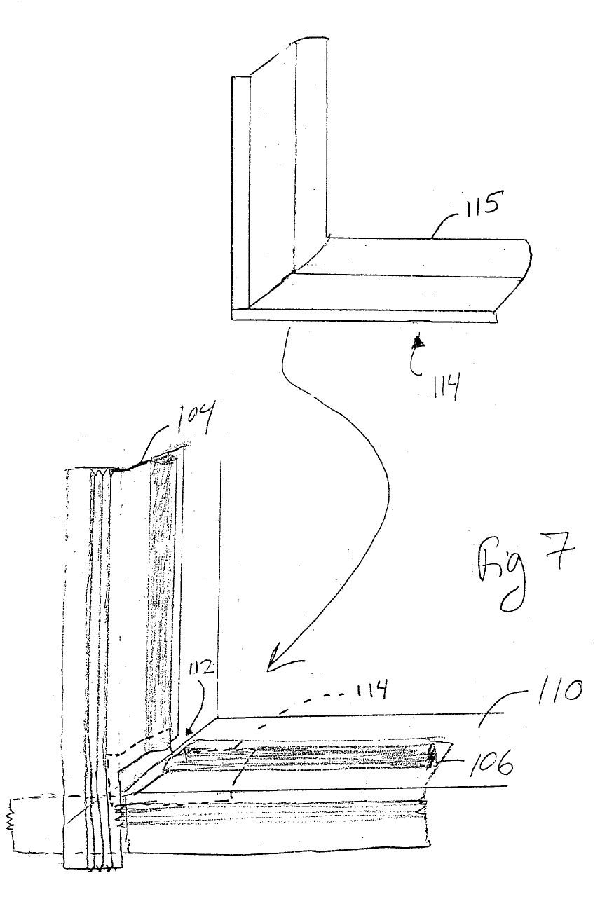

As shown in FIG. 6, the extrusion 70 is bent around the hinge 76 such that the inner lip 72 is seated within the rough opening 90. The extrusion 70 may include an adhesive on its rear surface such that the extrusion adheres to the rough opening and the outer wall. Alternatively, fastening members may be used to secure the inner lip and outer flange to the rough opening.

To complete the flashing assembly, a folded material/building paper/waterproof sheet 94 is placed behind the outer flange 74 and folded at a point 96 such that the outer portion of the fold forms an outer flap 98 that is sealed over the nailing flange of the window. Preferably, an adhesive 100 that is covered with a removable backing that may be placed on the inner surface of the outer flap 98 to seal the outer flap to the nailing flange. In addition, an adhesive 95 that is covered with a removable backing material may be placed on the inner surface of the outer flange 94 where the flange engages the wall to secure the outer flange to the wall. Finally, the outer flap 98 may include one or more stiffening members (not shown).

Although the extrusion shown in FIGS. 5 and 6 is shown having the water dam/air barrier 78 and the integrally formed weather strip 80, it will be appreciated that these elements may be omitted, if desired. The advantage of the extruded flashing assembly 70, as shown in FIGS. 5 and 6, is that the flashing assembly may be formed as a roll for convenient transport and handling.

Alternatively, the extrusions may be formed as strips sold in lengths of common window dimensions. The extrusion 70 is preferably formed of a flexible rubber material, such as EPDM. However, other materials could be used, depending upon their abilities to resist water penetration, chemical elements, and degradation of the material over time.

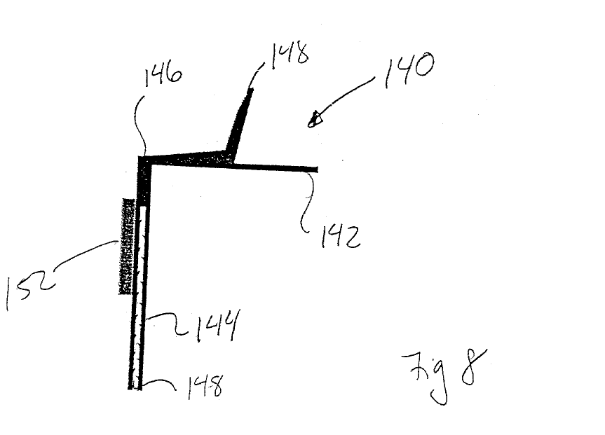

If the flashing assembly utilizes only straight members as shown in FIGS. 5 and 6, it may be necessary to further seal the comers of a window. Therefore, a corner block of the type shown in FIG. 7 may be used. When flashing assemblies 104, 106 are placed into a rough opening 110, a gap 112 may be present at the comer. Therefore, a corner block 114 having a sealed comer can be placed in the comer over the extruded flashing assemblies 104, 106 to create a seal at the comer of the rough opening. The comer blocks 114 may be made of a rubberized material or plastic and having an adhesive with removable backing material on its interior surface to ensure a good seal with the extruded flashing assemblies. The comer block is installed within the rough opening at its corner and outer edge. In addition, the comer block 114 may include a raised section 115 that interlocks over the water dam/air barrier of the two adjacent flashing assemblies.

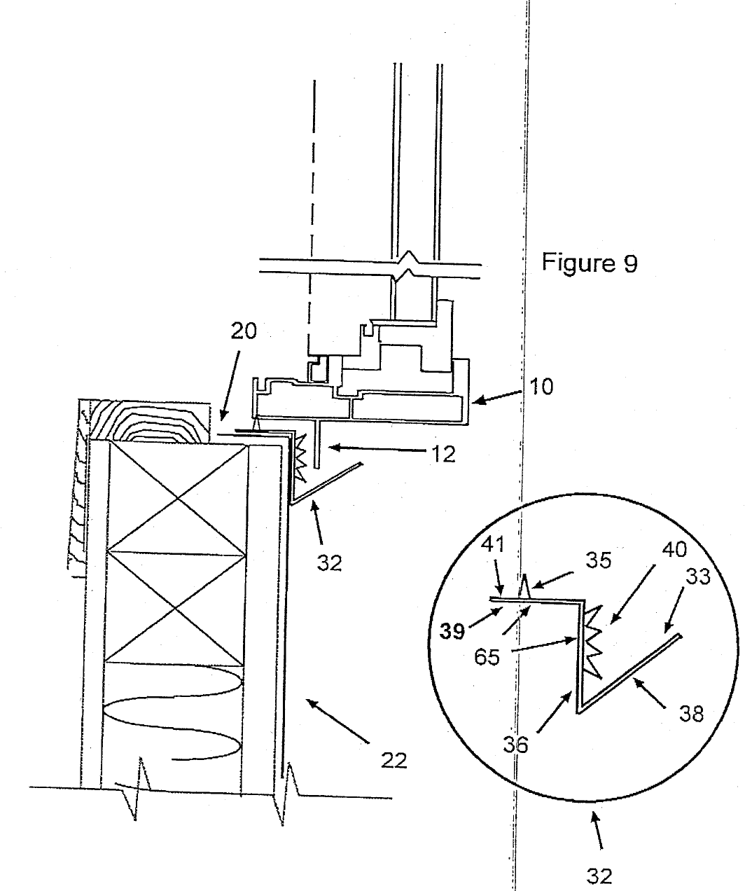

An alternate embodiment of the extruded flashing assembly is shown in FIG. 8. Here, the flashing assembly 140 is made of a less flexible material, such as plastic. The flashing assembly 140 includes an inner lip 142 and an outer flange 144 that are joined at approximately 90 degrees at a point 146. In addition, the flashing assembly may include an integrally formed water dam/air barrier 148 on the inner lip 142. The flashing assembly 140 may include an adhesive on its interior surface such that the flashing assembly can be secured within a rough opening. Alternatively, the extruded inner lip and outer flange may be secured in the rough opening with one or more fasteners.

To secure a folded sheet to complete the outer flange and outer flap assemblies, the outer flange 144 may include a slot 148 having a number of teeth or mechanical projections and/or an adhesive disposed therein to receive a sheet of asphalt paper or building wrap, etc. The asphalt paper or building wrap is inserted into the slot then folded back on itself to complete the outer flap of the flashing assembly. The asphalt paper or building wrap that is folded over the nailing flange of the window to be installed. In addition, the flashing assembly may include a weather strip 152 on the outer flange to provide further seal behind the nailing flange.

An alternate embodiment of the extruded flashing assembly demonstrating installation over a weather resistive barrier is shown in FIG. 9. The window or door frame 10 and nailing flange 12 are shown in proximity a weather resistive barrier 22 extended into the rough opening 20. The flashing assembly 32 is comprised of an inner lip 39 integrally formed to the outer flange 36 that is integrally formed to the outer flap 38. The inner lip 39 may have an integrally formed water air barrier 35 that seals the rough opening gap upon window or door installation. The inner lip 39 and the outer flange 36 may have an adhesive material 65 with removable backing. The inner lip may be adhered to the surface of the rough opening by staples at area 41. The outer flange 36 may have an integrally formed compressible seal 40 that may be comprised of several sealing fins. The outer flap 38 has adhesive material 33 with removable backing that is folded over the windows nailing flange 12 after the window is secured into the rough opening 20. It is recognized that the outer flange 36 and the outer flap 38 may vary in dimension from as little as 1 inch to as much as 10 to 12 inches depending upon the materials used and function desired.

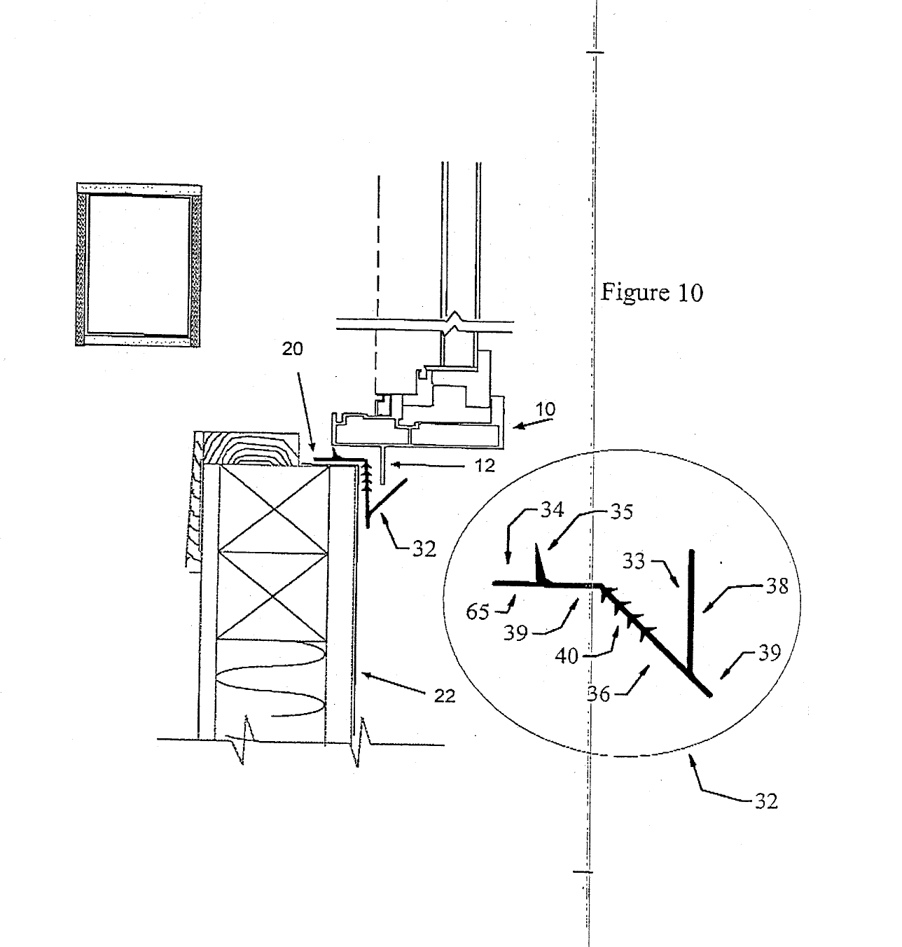

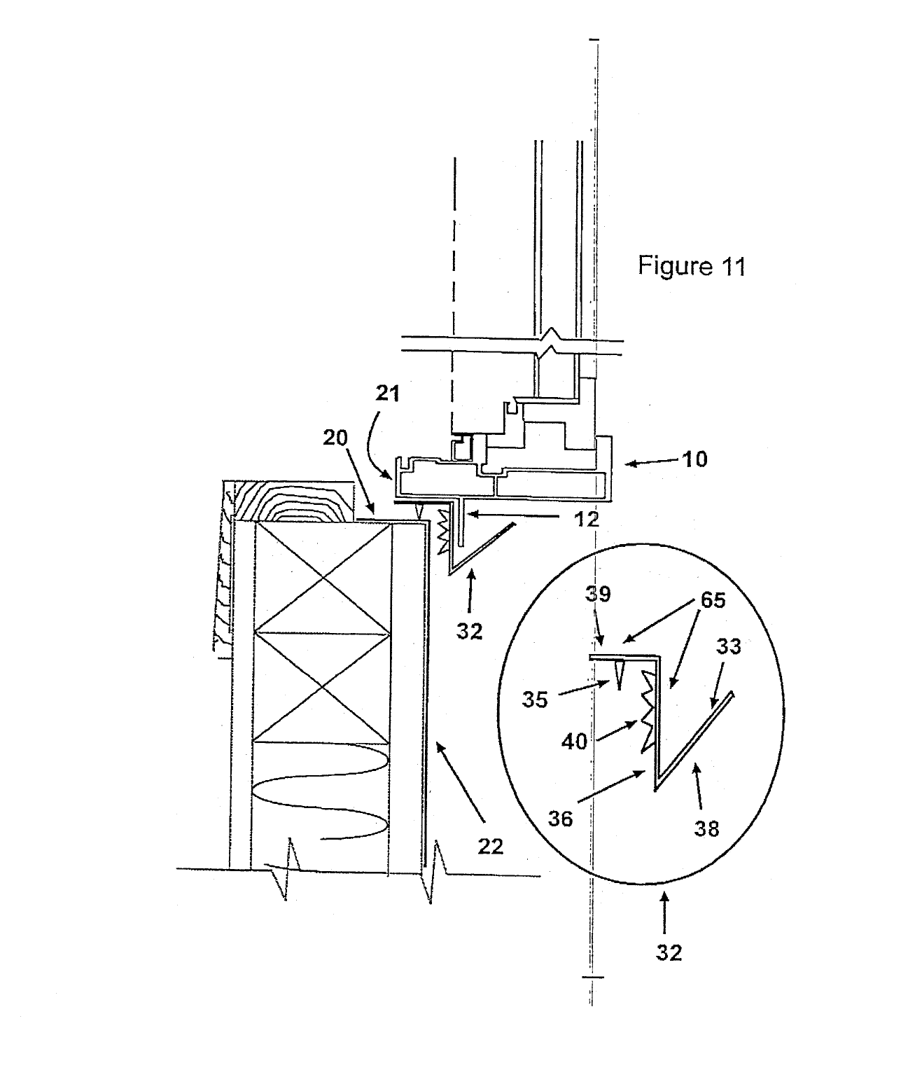

An alternate embodiment of the extruded flashing assembly demonstrating a compressible seal to both the weather resistive barrier covering the building sheathing area around the rough opening and the nailing flange is shown in FIG. 10. The window or door frame 10 and nailing flange 12 are shown in proximity of a weather resistive barrier 22 extended into the rough opening 20. The flashing assembly 32 is comprised of an inner lip 39 integrally formed to the outer flange 36 that is integrally formed to the outer flap 38. The inner lip may have an integrally formed water air barrier 35 that seals the rough opening to window or door gap. The inner lip 39 may have an adhesive material 65 with removable backing providing adhesion to the inner surface of the rough opening. The inner lip may be adhered to the surface of the rough opening by staples at area 34. The outer flange 36 may have an integrally formed compressible seal 40, which may be comprised of several sealing fins, formed on the flange inner and outer surfaces. The outer flap 38 has adhesive material 33 with removable backing that is folded over the windows nailing flange 12 after the window is secured into the rough opening 20. It is recognized that the outer flange 36 and the outer flap 38 may vary in dimension from as little as 1 inch to 10 to 12 inches depending upon the materials used and function desired. The outer flange 36 may be secured to the buildings exterior sheathing by staples at 39. The outer flange may be further extended over the buildings exterior sheathing by extension at point 39. This embodiment provides an alternative sealing mechanism between the rough opening 20 and the windows nailing flange 12.

An alternate embodiment of the extruded flashing assembly demonstrating the flashing assembly installation adhered to the window or door assembly is shown in FIG. 11. The window frame 10 and nailing flange 12 are shown in proximity of a weather resistive barrier 22 extended into the rough opening 20. The flashing assembly 32 is comprised of an inner lip 39 integrally formed to the outer flange 36 that is integrally formed to the outer flap 38. The inner lip may have an integrally formed water air barrier 35 that closes the rough opening to window or doorjamb gap. The inner lip 39 and the outer flange 36 have an adhesive material 65 that secure the flashing assembly to the jamb 21 and the nailing flange 12 respectively. The outer flange 36 may have an integrally formed compressible seal 40 that may be comprised of several sealing fins. The outer flap 38 has adhesive material 33 with removable backing that is folded over the nailing flange 12 after the window or door is secured into the rough opening 20. This embodiment provides the alternative to adhere the window flashing assembly to the window or door assembly prior to installation in the rough opening and potentially in a factory setting.

As can be seen from the above, the present invention provides a simple and convenient mechanism for improving the seal of windows.

While the present invention has been described with respect to its preferred embodiments, those skilled in the art will recognize that various changes may, be made without departing from the scope of the present invention. It is therefore intended that the scope of the invention be determined solely from the following claims and the equivalents thereto.

The embodiments of the invention in which an exclusive property or privilege is claimed are defined as follows:

1. A window or door flashing assembly comprising:
an extrusion including an extruded inner lip that fits within an inner surface of a rough opening;
an outer flange integrally formed with the inner lip and extending outwardly therefrom to cover a portion of a wall surrounding the rough opening; and
an outer flap including a water impervious member bonded at one edge to the outer flange and folded to seal a nailing flange of a window within the outer flap.

2. The flashing assembly of claim 1, wherein the inner lip of the extrusion has an adhesive with removable backing to adhere the inner lip to the rough opening.

3. The flashing assembly of claim 1, wherein the inner lip of the extrusion has an extended surface to permit the inner lip to be stapled to the rough opening.

4. The flashing assembly of claim 1, wherein the inner lip of the extrusion has an integrally formed water dam or air barrier.

5. The flashing assembly of claim 1, wherein the outer flange has a wall sheathing side with an adhesive strip with removable backing to provide adhesion to the wall sheathing.

6. The flashing assembly of claim 1, wherein the outer flange of the extrusion includes an integrally formed weather strip that aligns with an inner surface of the nail flange.

7. The flashing assembly of claim 1, wherein the outer flange of the extrusion includes an integrally formed weather strip that aligns with a water resistive barrier extended over the wall sheathing.

8. The flashing assembly of claim 6 wherein the weather strip has several sealing fins.

9. The flashing assembly of claim 7, wherein the weather strip has several sealing fins.

10. The flashing assembly of claim 1, wherein the outer flap has an adhesive that once folded is aligned with the outer surface of the nailing flange.

11. The flashing assembly of claim 1, wherein the extrusion is formed of a flexible rubber material.

12. The flashing assembly of claim 1, wherein the extrusion is formed of a plastic material.

13. The flashing assembly of claim 1, wherein the outer flange includes an adhesive on its inner surface to facilitate the adhesion of the flashing assembly to a wall.

14. The flashing assembly of claim 1, further comprising a comer block that seals a comer where adjacent flashing assemblies meet.

15. The flashing assembly of claim 14, wherein the corner block includes a raised section that completes a water dam or air barrier on adjacent flashing assemblies.

16. The flashing assembly of claim 1, wherein the outer flange further includes one or more stiffeners.

17. The flashing assembly of claim 1, wherein the outer flange includes a slot in which an edge of the water impervious member is fitted.

18. The flashing assembly of claim 1, wherein the outer flange includes an extension beyond the point where the outer flap is joined providing a staple area.

19. The flashing assembly of claim 1, wherein the outer flange includes an extension beyond the point where the outer flap is joined extending the flange area covering the wall.

20. The flashing assembly of claim 1, wherein the outer flanges of adjacent assemblies and the outer flaps of adjacent assemblies may be interwoven when installed to provide a shingled layering around a rough opening.

21. A window or door flashing assembly adhered to a window or door comprising:
an extrusion including an extruded inner lip that can be adhered to the jamb of the window or door frame;
an extruded outer flange integrally formed with the inner lip and can be adhered to an inner surface of a nail flange of the door or window; and
an extruded outer flap integrally formed with the outer flange to seal a nailing flange of a window within the outer flap.

22. The flashing assembly of claim 21, wherein the inner lip of the extrusion has adhesive with removable backing to adhere the inner lip to the window or door jamb.

23. The flashing assembly of claim 21, wherein the inner lip of the extrusion has an integrally formed water dam or air barrier.

24. The flashing assembly of claim 21, wherein the outer flange of the extrusion has adhesive with removable backing to adhere the outer flange to the inner surface of the nailing flange.

25. The window flashing assembly of claim 21, wherein the outer flange of the extrusion includes an integrally formed weather strip that aligns with an outer surface of a building's sheathing surrounding the window or door rough opening.

26. The window flashing of assembly of claim 25 wherein the weather strip has several sealing fins.

27. The window flashing assembly of claim 21, wherein the outer flap has an adhesive that is aligned with the outer surface of the nailing flange.

28. The window flashing assembly of claim 21, wherein the outer flaps of adjacent assemblies are adapted to be interwoven to provide a shingled layering.
